(19) United States
(12) Patent Application Publication
(10) Pub. No.: US 2007/0039565 A1
(43) Pub. Date: Feb. 22, 2007

(54) Dog shoes

(75) Inventor: Elizabeth J. Krottinger, Addison, TX (US)

Correspondence Address: Peter J. Thoma;Thompson & Knight LLP, Suite 3300, 1700 Pacific Avenue, Dallas, TX, 75201, US

(73) Assignee: Presch, LLC

(21) Appl. No.: 11/204,696

(22) Filed: Aug. 16, 2005

(51) Int. Cl. A01K 13/00

(52) U.S. Cl. 119/850

(57) ABSTRACT

A dog shoe including a foot covering configured to fit a dog's foot and adapted for elastic expansion as required for placing the foot covering on the dog's foot and for maintaining the dog's foot covering in position on the dog's foot.

### FIELD OF THE INVENTION

The present invention relates to a dog shoe which is positionable on a dog's foot by elastic deformation of the shoe.

### BACKGROUND OF THE INVENTION

There have been many attempts to develop shoes or boots for dogs.

In U.S. Pat. No. 4,458,431 issued Jul. 10, 1984 to Suzanne E. Sinclair, a boot for a pet animal is shown comprising a sole member with a flexible upper attached together around the corresponding front and side edges.

U.S. Pat. No. 4,967,542 issued Nov. 6, 1990 to Bonita M. MacDonald, discloses a dog boot for the rear leg of a dog having a foot, a tarsus joint and a fibular tarsal with a sole extending from the foot to the tarsus joint and an upper heel section fastened to the sole and fixed proximally the tarsus joint shaped so that the boot is anchored on the leg by the fibular tarsal.

U.S. Pat. No. 5,148,657 issued Sep. 22, 1992 to Vondie A. Stafford, et al, discloses a dog boot which has as particular portions, a foot, ankle and calf with the calf and ankle being large enough to accommodate the dog's paw passing through with the front of the boot having a vertical opening and a vertical panel, which is closed by a horizontal belt fastenably at optionally chosen vertical places along the back of the boot.

U.S. Pat. No. 5,495,828 issued Mar. 5, 1996 to Irving Solomon, et al, discloses a mitten-like pet animal boot comprising a pliable sleeve integrally formed to define a stitchless sleeve wherein the stitchless sleeve defines an open top and a closed lower end and is maintained in position by a fastening strap.

U.S. Pat. No. 5,528,885 issued Jun. 25, 1996 to Sally B. Chamberlain, discloses footwear for hoofed animals and comprises basically a flexible sleeve which is maintained in place by laces for closing and opening.

U.S. Pat. No. 6,186,097 issued Feb. 13, 2001 to Sandra Brockmann, et al, discloses a protective shoes for a dog paw which comprises two layers, at least of one of which is a breathable, semi-permeable material elastically stretchable in both lengthwise and cross directions, which is impermeable to water from the outside and humidity from the inside wherein the protective shoe is maintained in place by two straps.

U.S. Pat. No. 6,470,832 issued Oct. 29, 2002 to Charlton Peacock, relates to an animal boot configured to be similar to a sleeve held in place by a strap.

U.S. Pat. No. 6,526,920 issued Mar. 4, 2003 to Robert Griffin, discloses a boot comprising a boot top portion including a zippered openable and closeable opening with a shield positioned around the front of the boot in its upper portion and maintained in position by a pair of straps.

U.S. Pat. No. 6,546,704 issued Apr. 15, 2005 to Lee A. Fisher, relates a dog boot comprising a planar flexible sheet of material having a high friction surface on one side and is formed having a leg-engaging section and a foot engaging section, each of which is intended to be wrapped around the leg and foot respectively of an animal.

U.S. Pat. No. 6,832,442 issued Dec. 21, 2004 to Patricia Lewis, et al, discloses an adjustably sizeable and protective boot for an animal which has two hook and loop straps, each drawn around the protective boot and fastened to itself and to fastening means. One strap is drawn around the foot covering portion between the toe end and the ankle covering portion and the other strap is drawn around the ankle covering portion.

All of the above-referenced patents are hereby incorporated by reference.

While these animal foot covers, most of which are for dogs, have been disclosed, none of the foot covers disclosed solves the most pressing problems for a dog shoe. Desirably a dog shoe is positionable on the dog's foot by expansion of the sidewalls and the foot covering portions of the boot and then at least partially retained in position on the dog's foot by the elasticity of the side walls of the dog shoe.

### SUMMARY OF THE INVENTION

The present invention provides a dog shoe comprising: a sole having a bottom and an outside; a sidewall having a front and a top, a back and a bottom connected to the sole around and near the outside of the sole with the sidewall extending to the top of the dog shoe; an expandable section in the front of the sidewall having an inside, a first and a second edge and a top and a bottom and extending to the top of the sidewall; and, an elastic member positioned in contact with the first and the second edges for urging the sides together.

The invention further comprises a dog shoe comprising: a foot covering configured to fit a dog foot and having a bottom, a top, a mid-section, sides, a front and a back with a sole on the bottom, the foot covering being adapted for elastic expansion and contraction as required for placing the foot covering on the dog foot and for elastically maintaining the foot covering in position on the dog foot.

The invention also comprises a dog shoe comprising: a foot covering configured to fit a dog foot and having a bottom, a top, a mid-section, sides, a front and a back with a sole on the bottom, the foot covering being adapted for elastic expansion and contraction as required for placing the foot covering on the dog foot and for elastically maintaining the foot covering in position on the dog foot; an opening in the sides defined by two flaps positioned at first and second edges of the opening with a tongue positioned inside and over the opening, the flaps being adapted to narrow the opening and tighten an inside circumference of the sides in the top and mid-section of the shoe when the flaps are moved closer to each other; and a strap in engagement with each edge; the strap being engageable with at least one edge by removeably matingly adherent patches; and, the foot covering includes at least one elastically expandable and contractible section positioned around the back of the dog shoe in the mid-section, extending along the sides on each side from the back and being elastically contractible to reduce an inside diameter of the sides.

### BRIEF DESCRIPTION OF THE DRAWINGS

FIG. 1. is a front view of an embodiment of the present invention;

FIG. 2. is a right-side view of the dog shoe of FIG. 1;

FIG. 3. is a left-side view of the dog shoe of FIG. 1;

FIG. 4. is a back view of the dog shoe of FIG. 1; and,

FIG. 5 is a top view of the dog shoe of FIG. 1.

### DESCRIPTION OF PREFERRED EMBODIMENTS

In the description of the Figures, the same numbers will be used throughout to refer to the same or similar components.

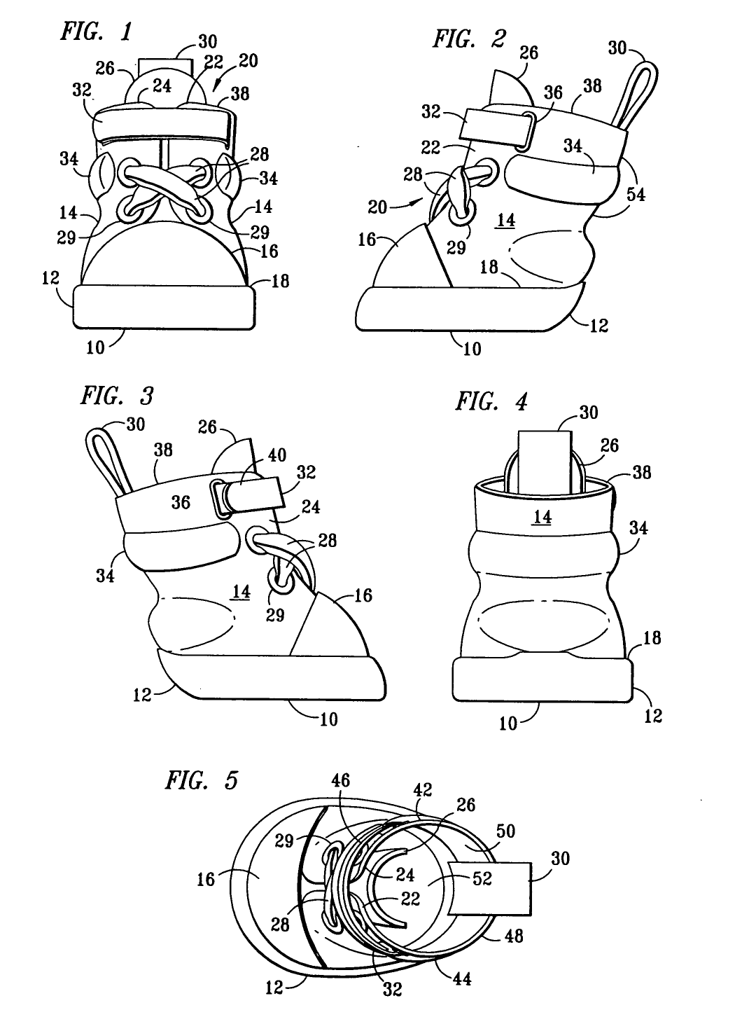

In FIG. 1 a dog shoe, according to the present invention, is shown. The dog shoe comprises a sole 10 having a strip 12 around the outside of the sole. The sidewalls 14 form the body of the shoe above the sole and are typically adhesively joined at their bottom 18 to the sole inside strip 12. Such fabrications are well known such as used in human exercise shoes and the like.

A toe 16 is also included. An expandable section 20 comprising a first and second edge 22 and 24 is included in the shoe. The first and second edge have a tongue 26 positioned behind the opening between the first and second edge which are adapted to reduce an inner circumference of the shoe body sidewall when the first and second edges are drawn together. As shown, elastic laces 28 are used for this purpose. These laces are not designed for and are not effective for use to tie the shoe. These laces are shown as elastic members which are positioned to urge the first and second edge together to elastically reduce the inner circumference of the sidewalls of the shoe. Eyelets 29 are shown for positioning the elastic laces 28 in contact with the first and second edge. A pull strap 30 is optionally positioned on the back of the shoe, as shown and the tongue 26 typically extends above a top 38 of the sidewalls 14. A strap 32 is positioned in engagement of a first edge 22 at a distance removed toward the back of the shoe from the edge and second edge 24 with the engagement of strap 32 with the second edge being removed a distance from the second edge toward the back of the shoe. Strap 32 is used to tighten the top of the shoe. The strap may be connected to a buckle or ring-like fitting 36 at its first end and by a Velcro fastener or tightly matingly engaging patches 40 at its second end.

In FIG. 2 the side view shows more clearly the presence of an expandable and contractible section 34 on the back of the dog shoe. Section 34 extends around sides of the shoe in a mid-section 54 of the shoe which generally is the ankle section of the shoe. Expandable and contractible section 34 comprises elastomeric members positioned in the sidewalls of the shoe to contract to reduce the inner circumference of the sidewalls 14. When the shoe is urged on to a dog's foot, strap 32 is released and the shoe is placed on the dog's foot and is retained in the place by the action of expandable section 20 and elastic laces 28 and expandable and contractible section 34, which closely engage the dog's paw with an inside 50 of the shoe. As further assurance that the dog's shoe will remain in place, strap 32 is drawn tightly around the dog's leg above top 38 of the dog shoe and fastened with tightly engaging patches into fixed engagement to further hold the dog's shoe on the dog's foot. These fasteners may be hook and loop type fasteners marketed by Velcro, Inc. or other suitable fasteners as known to the art.

In FIG. 3 a connection 40 is shown on strap 32, which is in engagement with a ring 36 on a side of the dog's shoe which engages an adhesive patch of material which is engageable by a comparable adhesive patch of material on the end of strap 32, such as a Velcro fastener.

In FIG. 4 a back view of the dog shoe is shown illustrating expandable and contractible section 34 in somewhat greater detail. Section 34 may comprise a gathered side material section.

In FIG. 5 a top view of the dog shoe is shown. In this view, a first side 42, a second side 44, a third side 46 and a fourth side 48 of the sidewall 14 of the shoe is shown. The third side corresponds to the front and the fourth side corresponds to the back of the shoe. An inner lining 52 of the shoe is formed of materials which are suitable generally for the lining of human shoes and is generally a soft pliable material to provide maximum comfort to the bottom of the dog's foot when the shoe is in place. Further the inside of the sidewalls is indicated by the numeral 50. As indicated previously, the inside circumference of the sidewall is reducible by expandable and contractible section 34 and by expandable section 40, which can be contracted by elastic laces 28. Toe 16 of the shoe is shown more clearly in this view.

In the fabrication of shoes of the present invention, desirably the sole is formed of any suitable rubber or rubberized material with the strip also typically being formed for a rubberized material. These shoes can be formed by techniques well known to those skilled in the art for the production of exercise shoes and the like for humans. Many such shoes produced for humans have cloth or rubberized cloth sidewalls. Such materials are also suitable for the production of the shoes of this invention.

The shoes of the present invention may be produced in a variety of sizes to fit the feet of dogs of various sizes and may be formed of materials of different colors and textures. While white is normally a preferred color for the formation of the strip and toe, it is by no means so limited and any color could be used. Further, any color can be used for the sidewalls of the shoe and for the tongue, and pull strap of the shoe. Optionally the elastic laces may be of a contrasting color with the body of the shoe for ornamental purposes.

As discussed above, by release of the strap it is considered that the present shoe is readily installable on a dog's foot by elastomeric expansion of the circumference of the inside of the sidewalls. After installation, the elastomeric forces supplied by elastic laces 28 and expandable and contractible section 34 continue to hold the dog shoe in place on the dog's foot. While the invention is considered to be effective without the presence of strap 32, it is considered desirable to use strap 32 to further ensure that the dog shoe remains in place. While the use of adhesive patches is shown, a buckle or a snap adjustable positioned on the strap and the like could be used to fasten the end of strap 32. While rings 36 are shown to engage the ends of strap 32, the ends could be equally well be sewn or otherwise permanently fixed into the sidewalls.

While expandable and contractible section 34 has been discussed as a single section, it should be appreciated that a plurality of elastomeric sections having elastomeric members extending around the first and second sides of the dog shoe from the fourth side (back) could be and desirably are used. The strength of the elastomeric members may be adjusted as considered suitable for the comfort of the dog's foot and the need for compression on the inside of the sidewalls to keep the dog shoe in place.

It is also clear that more than two eyelets could be used with a more extensive network of laced elastomers on the front of the shoe between the first and second edges. The edges as shown generally extend only to the top of the foot portion of the shoe and do not extend below the ankle and leg portions of the sidewall.

By contrast to previous dog shoes, which rely upon zippers and fixed restraining bands and the like, the present invention has overcome the disadvantages associated with such fasteners by the use of elastomeric members which retain the dog shoe in place and facilitate positioning it in place. The present invention has significant advantages over previous dog shoes in that it does not require the additional fixed straps or zippers to fasten the dog shoe firmly in place on the dog's foot. Such devices rely upon the shoe body being closely fitted to the dog's foot initially. It is well known that there may be considerable variations in the size of dog's feet and that it may be difficult to achieve such close fits so that they may be closed by closing devices which are fixed with respect to the resulting inside circumference of the dog shoe body.

According to the present invention, these difficulties are overcome by using primarily elastomeric members to permit the installation of the dog's foot into the dog shoe and the retention of the dog shoe on the dog's foot. Strap 32 is readily varied with respect to the tightness achieved by strap 32 by using a relatively long pad and adjustable snap or belt and the like for engagement on the attaching end of strip 42.

While the present invention has been described by reference to certain of its preferred embodiments, it is pointed out that the embodiments described are illustrative rather than limiting in nature and that many variations and modifications are possible within the scope of the present invention. Many such variations and modifications may be considered obvious and desirable by those skilled in the art based upon a review of the foregoing description of preferred embodiments.

What is claimed is:

1. A dog shoe comprising:
a) a sole having a bottom and an outside;
b) a sidewall having a front and atop, a back and a top and a bottom connected to the sole around and near the outside of the sole with the sidewall extending to a top of the dog shoe;
c) an expandable section in the front of the sidewall having an inside, a first and a second edge and a top and a bottom and extending to the top of the sidewall; and,
d) an elastic member positioned in contact with the first and the second edges for urging the sides together.

2. The dog shoe of claim 1 wherein a tongue is positioned inside the expandable section to cover the inside of the expandable section.

3. The dog shoe of claim 2 wherein the elastic member is configured as elastic laces connecting the first and second sides of the expandable section.

4. The dog shoe of claim 1 wherein the dog shoe includes a strap having a first and a second end near the top of the sidewall and connectable to the first edge and the second edge of the expandable section and adapted to urge the first and second edges of the expandable section together.

5. The dog shoe of claim 4 wherein at least one end of the strap is connected to at least one side of the expandable section with a Velcro fastener.

6. The dog shoe of claim 1 wherein the dog shoe includes an elastically expandable and contractible section positioned in the mid-portion of the back of the shoe, connected to a portion of the fist side and a portion of the second side of the sidewall and around the back of the sidewall and adapted to urge the portions of the first and second sides to a reduced inside circumference.

7. The dog shoe of claim 6 wherein the reduced circumference comprises a gathered side material section.

8. The dog shoe of claim 6 wherein the dog shoe includes a plurality of elastomeric members.

9. The dog shoe of claim 1 wherein the sole further comprises an outer sole configured to extend upward over a portion of the sidewall.

10. A dog shoe comprising a foot covering configured to fit a dog foot and having a bottom, a top, a mid-section, sides, a front and a back with a sole on the bottom, the foot covering being adapted for elastic expansion and contraction as required for placing the foot covering on the dog foot and for elastically maintaining the foot covering in position on the dog foot.

11. The dog shoe of claim 10 wherein the foot covering includes an opening in the sides defined by two flaps positioned at first and second edges of the opening with a tongue positioned inside and over the opening, the flaps being adapted to narrow the opening and tighten an inside circumference of the sides in the top and mid-section of the shoe when the flaps are moved closer to each other.

12. The dog shoe of claim 11 wherein the flaps are urged together by an elastic member positioned in engagement with each of the sides.

13. The dog shoe of claim 11 wherein the foot covering includes a strap in engagement with each edge.

14. The dog shoe of claim 13 wherein the strap is engageable with at least one edge by removeably matingly adherent patches.

15. The dog shoe of claim 10 wherein the foot covering includes at least one elastically expandable and contractible section positioned around the back of the dog shoe in its mid-section, extending along the sides on each side from the back and being elastically contractible to reduce an inside diameter of the sides.

16. The dog shoe of claim 15 wherein the dog shoe includes a plurality of elastically expandable and contractible sections.

17. A dog shoe comprising:
a) a foot covering configured to fit a dog foot and having a bottom, a top, a mid-section, sides, a front and a back with a sole on the bottom, the foot covering being adapted for elastic expansion and contraction as required for placing the foot covering on the dog foot and for elastically maintaining the foot covering in position on the dog foot;
b) an opening in the sides defined by two flaps positioned at first and second edges of the opening with a tongue positioned inside and over the opening, the flaps being adapted to narrow the opening and tighten an inside circumference of the sides in the top and mid-section of the shoe when the flaps are moved closer to each other;
c) a strap in engagement with each edge;
d) the strap is engageable with at least one edge by removeably matingly adherent patches; and,
e) the foot covering includes at least one elastically expandable and contractible section positioned around the back of the dog shoe in the mid-section, extending along the sides on each side from the back and being elastically contractible to reduce an inside diameter of the sides.

18. The dog shoe of claim 17 wherein the flaps are urged together by an elastic member positioned in engagement with each of the sides.

19. The dog shoe of claim 17 wherein the dog shoe includes a plurality of elastically expandable and contractible sections.
